(19) United States
(12) Patent Application Publication
(10) Pub. No.: US 2019/0160960 A1
(43) Pub. Date: May 30, 2019

(54) FEE SETTING DEVICE AND FEE SETTING METHOD FOR CAR SHARING FEE

(71) Applicant: Toyota Jidosha Kabushiki Kaisha, Toyota-shi (JP)

(72) Inventors: Aya Onodera, Nisshin-shi (JP); Akihiko Nakanishi, Nisshin-shi (JP); Takumi Hamajima, Osaka-shi (JP); Yusuke Tsutsui, Anpachi-gun (JP)

(73) Assignee: Toyota Jidosha Kabushiki Kaisha, Toyota-shi (JP)

(21) Appl. No.: 16/196,327

(22) Filed: Nov. 20, 2018

(30) Foreign Application Priority Data
Nov. 24, 2017 (JP) 2017-226104

(51) Int. Cl. B60L 11/18; G06Q 50/06; G06Q 30/02

(52) U.S. Cl. CPC B60L 11/1848; B60Y 2200/91; G06Q 30/0283; G06Q 50/06

(57) ABSTRACT

When a first electric vehicle is reserved, a fee setting device estimates an SOC of the first electric vehicle at the time of arrival at a destination as a first estimated SOC. When the fee setting device determines that the first estimated SOC is less than a predetermined value, the fee setting device sets a vehicle change station and presents it to a user. When the user changes the first electric vehicle to a second electric vehicle at the vehicle change station, the fee setting device applies a first vehicle change discount to a utilization fee for the second electric vehicle.

This nonprovisional application is based on Japanese Patent Application No. 2017-226104 filed on Nov. 24, 2017 with the Japan Patent Office, the entire contents of which are hereby incorporated by reference.

### BACKGROUND

### Field

The present disclosure relates to setting a car sharing fee for an electric vehicle traveling using power stored in a power storage device.

### Description of the Background Art

Car sharing allowing a plurality of users to share a single vehicle is increasingly utilized. Car sharing means that a user himself/herself does not own a vehicle, and instead the user obtains membership of a car sharing business operator and utilizes a vehicle owned by the business operator as appropriate. In recent years, as electric vehicles are increasingly used, the electric vehicles are also increasingly used in car sharing.

Generally, the travelable distance of an electric vehicle with a fully-charged power storage device is shorter than that of a gasoline-powered vehicle driven by an internal combustion engine. Accordingly, in electric vehicle car sharing (hereinafter also referred to as “EV car sharing”), in a case where a user drives an electric vehicle for a relatively long distance, the user has to charge a power storage device of the electric vehicle on the way to a destination, which is inconvenient for the user.

Japanese Patent Laying-Open No. 2011-214895 discloses a vehicle change guidance device which guides a vehicle change location and a next riding vehicle when it is determined that a vehicle cannot arrive at a destination set by a user without additional charging.

### SUMMARY

Generally, an electric vehicle requires a longer time for replenishment of driving energy than that for a gasoline-powered vehicle driven by an internal combustion engine. Specifically, the time required for replenishment of driving energy is the time required to supply gasoline in the case of the gasoline-powered vehicle, and is the time required to charge a power storage device in the case of the electric vehicle.

Accordingly, in EV car sharing, a user willingly selects an electric vehicle in which a state of charge (hereinafter also referred to as an “SOC”) of a power storage device of the electric vehicle reaches a certain charge level or more. On the other hand, a user may not select an electric vehicle in which the SOC is less than the certain level, and the efficiency of utilizing EV car sharing may be reduced.

Thus, there is a demand for an EV car sharing system which encourages utilization of an electric vehicle in which the SOC does not reach a certain level or more. Japanese Patent Laying-Open No. 2011-214895 is silent about such a problem and measures against the problem.

The present disclosure has been made to solve the aforementioned problem, and an object thereof is to enhance the efficiency of utilizing an electric vehicle in electric vehicle car sharing.

A fee setting device in accordance with the present disclosure is configured to set a utilization fee for sharing an electric vehicle. The fee setting device includes: a vehicle change location setting unit configured to set a vehicle change location for changing a first electric vehicle to a second electric vehicle, based on designated place of departure and destination; and a fee setting unit configured to set the utilization fee. In a first case where the first electric vehicle is changed to the second electric vehicle at a first vehicle change location, the fee setting unit is configured to set the utilization fee to be lower than that in a second case where the first electric vehicle is not changed to the second electric vehicle at the first vehicle change location.

A fee setting method in accordance with another aspect of the present disclosure is configured to set a utilization fee for sharing an electric vehicle. The fee setting method includes: setting a vehicle change location for changing a first electric vehicle to a second electric vehicle, based on designated place of departure and destination; and setting the utilization fee in a case where the first electric vehicle is changed to the second electric vehicle at the vehicle change location, to be lower than that in a case where the first electric vehicle is not changed to the second electric vehicle at the vehicle change location.

According to the above configuration, by changing the electric vehicle to another electric vehicle at the vehicle change location, the utilization fee is set to be lower than that in the case where the electric vehicle is not changed at the vehicle change location. Thereby, a user is encouraged to use an electric vehicle with a power storage device having a low power storage amount to travel to the vehicle change location, and then change the electric vehicle to another electric vehicle at the vehicle change location to travel to the destination. Accordingly, utilization of the electric vehicle with the power storage device having a low power storage amount is promoted. Therefore, the efficiency of utilizing the electric vehicle is enhanced.

The fee setting unit estimates the utilization fee in each of the first case and the second case.

According to the above configuration, since the utilization fees are estimated, there is an increased possibility that the user may select utilization of changing the electric vehicle at the vehicle change location, which is advantageous in terms of the fee. Therefore, the efficiency of utilizing the electric vehicle is enhanced.

The first and second electric vehicles each include a power storage device mounted thereon. The fee setting device estimates a power storage amount in the power storage device of the first electric vehicle at the destination in the second case as a first estimated power storage amount. When the first estimated power storage amount is lower than a predetermined value, the vehicle change location setting unit sets the first vehicle change location as the vehicle change location.

According to the above configuration, the vehicle change location is set when the first estimated power storage amount at the destination in the second case is lower than the predetermined value. When the first estimated power storage amount at the destination in the second case is more than or equal to the predetermined value, a next user can utilize the electric vehicle relatively promptly. The above configuration suppresses a vehicle change location from being set even in such a case.

In a case where the vehicle change location setting unit sets the first vehicle change location, the fee setting device estimates a power storage amount in the power storage device of the second electric vehicle at the destination in the first case as a second estimated power storage amount. When the second estimated power storage amount is lower than the predetermined value, the vehicle change location setting unit further sets a second vehicle change location.

According to the above configuration, another vehicle change location is further set when the second estimated power storage amount at the destination in the first case is lower than the predetermined value. Thereby, another vehicle change location is further set when it is estimated that the electric vehicle will be returned with a power storage amount lower than the predetermined value. The above configuration promotes returning the electric vehicle with a power storage amount more than or equal to the predetermined value, and enhances the efficiency of utilizing the electric vehicle.

In a case where the vehicle change location setting unit sets the first vehicle change location, the fee setting device estimates a power storage amount in the power storage device of the first electric vehicle at the first vehicle change location as a third estimated power storage amount. The third estimated power storage amount is required to set a power storage amount in the power storage device of the second electric vehicle at the destination in the first case to more than or equal to the predetermined value. When the third estimated power storage amount is more than or equal to a threshold value, the vehicle change location setting unit further sets a third vehicle change location.

According to the above configuration, the third estimated power storage amount of a next riding vehicle (second electric vehicle) is estimated, which is required to set the power storage amount in the power storage device of the next riding vehicle at the destination in the first case to more than or equal to the predetermined value. Another vehicle change location is further set when the third estimated power storage amount is more than or equal to the threshold value. This promotes returning the electric vehicle with a power storage amount more than or equal to the predetermined value at each vehicle change location and the destination, and enhances the efficiency of utilizing the electric vehicle.

When the vehicle change location is set, in a case where a power storage amount in a power storage device mounted in a drop-off vehicle, which is the electric vehicle before being changed, is higher than a reference value, the fee setting unit sets a utilization fee for the drop-off vehicle to be lower than that in a case where the power storage amount in the power storage device of the drop-off vehicle is lower than the reference value.

According to the above configuration, in the case where the power storage amount in the power storage device of the drop-off vehicle is higher than the reference value, the fee is set to be lower than that in the case where the power storage amount in the power storage device of the drop-off vehicle is lower than the reference value. Thus, the user is encouraged to return the drop-off vehicle with a power storage amount higher than the reference value remaining therein. This reduces the time required to charge the drop-off vehicle after the drop-off vehicle is returned, and thus enhances the efficiency of utilizing the electric vehicle.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a diagram schematically showing an overall configuration of a fee setting system in accordance with the present embodiment.

FIG. 2 is a diagram showing an example of a detailed configuration for charging an electric vehicle in accordance with the present embodiment.

FIG. 3 is a functional block diagram showing a configuration of a controller of a fee setting device in accordance with the present embodiment.

FIG. 4 is a diagram showing an example of a configuration of a user list stored in the fee setting device in accordance with the present embodiment.

FIG. 5 is a diagram showing an example of a selection screen displayed in a communication terminal in accordance with the present embodiment.

FIG. 6 is a diagram showing an example of a configuration of an application list stored in the fee setting device in accordance with the present embodiment.

FIG. 7 is a flowchart showing processing performed by the fee setting device in accordance with the present embodiment.

FIG. 8 is a flowchart showing processing in creating a vehicle change plan performed by the fee setting device in accordance with the present embodiment.

FIG. 9 is a flowchart showing processing in normal utilization performed by the fee setting device in accordance with the present embodiment.

FIG. 10 is a flowchart showing processing in vehicle change utilization performed by the fee setting device in accordance with the present embodiment.

FIG. 11 is a flowchart showing processing at the time of self-pay charging performed by the fee setting device in accordance with the present embodiment.

FIG. 12 is a diagram for explaining examples to which the configuration of the present embodiment is applied.

FIG. 13 is a flowchart showing processing in creating a vehicle change plan performed by the fee setting device in accordance with a variation.

### DESCRIPTION OF THE PREFERRED EMBODIMENTS

An embodiment of the present disclosure will now be described in detail with reference to the drawings. In the figures, identical or corresponding components are identically denoted and will not be described repeatedly.

### As to Configuration of Fee Setting System

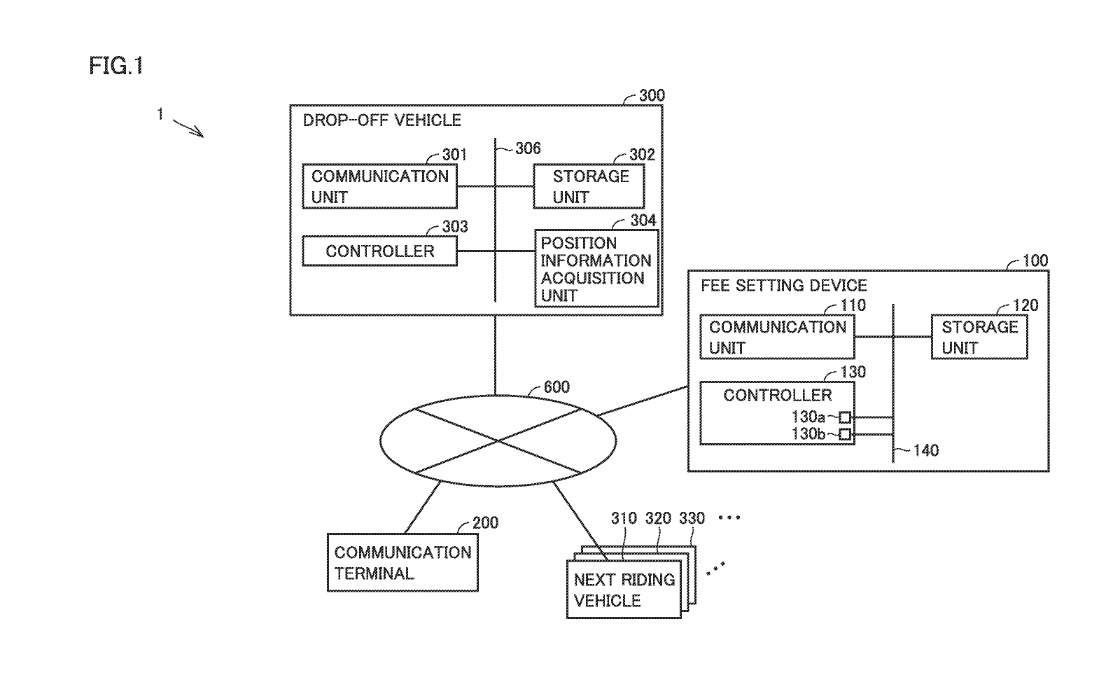

FIG. 1 is a diagram schematically showing an overall configuration of a fee setting system 1 in accordance with the present embodiment. As shown in FIG. 1, fee setting system 1 in accordance with the present embodiment includes a fee setting device 100, a communication terminal 200, a drop-off vehicle 300 which is an electric vehicle (hereinafter also referred to simply as a “drop-off vehicle”), and next riding vehicles 310 to 330 which are electric vehicles (hereinafter also referred to simply as “next riding vehicles”). It should be noted that drop-off vehicle 300 and next riding vehicles 310 to 330 will also be collectively referred to simply as “vehicles”. In addition, when a description is given of next riding vehicles 310 to 330, the description will be given using next riding vehicle 310 as a representative.

Communication terminal 200 is a communication terminal used by a user of fee setting system 1 in accordance with the present embodiment, and is, for example, a smartphone, a personal computer, or the like. Using communication terminal 200, the user reserves a vehicle for a car sharing service which uses fee setting system 1, or selects a manner of utilizing drop-off vehicle 300 described later.

Drop-off vehicle 300 is an electric vehicle utilized by the user from a place of departure. Next riding vehicles 310 to 330 are used as electric vehicles utilized after the user gets off drop-off vehicle 300 at a vehicle change location described later. Since the configuration of next riding vehicles 310 to 330 is the same as the configuration of drop-off vehicle 300, only the configuration of drop-off vehicle 300 will be described.

Fee setting device 100 includes a communication unit 110, a storage unit 120, and a controller 130. Each component is communicatively connected by a communication bus 140.

Communication unit 110 is configured to allow communication with a communication unit 301 of drop-off vehicle 300, for example. Communication between communication unit 110 and communication unit 301 is performed via a communication network 600 such as the Internet or a telephone line. Further, communication unit 110 can also communicate with next riding vehicles 310 to 330.

In addition, communication unit 110 is configured to allow communication with communication terminal 200. Communication between communication unit 110 and communication terminal 200 is also performed via communication network 600.

Storage unit 120 includes, for example, a large-capacity storage device such as a hard disk drive or a solid state drive. Storage unit 120 stores information of users who have made membership registration for car sharing, position information of stations serving as vehicle change locations for vehicles, and the like. Further, storage unit 120 stores a user list 700 storing information of a destination and a place of departure, information about states of charge (hereinafter also referred to as “SOCs”) and positions of drop-off vehicle 300 and next riding vehicles 310 to 330, and the like, for each user. Details of user list 700 will be described later.

Controller 130 includes a CPU (Central Processing Unit) 130a, a memory (ROM and RAM) 130b, input/output ports (not shown) for inputting/outputting various signals, and the like. Controller 130 is configured to execute predetermined computation processing based on information stored in memory 130b and storage unit 120, and information received from drop-off vehicle 300 and next riding vehicles 310 to 330 via communication unit 110. Details of controller 130 will be described later.

Drop-off vehicle 300 includes communication unit 301, a storage unit 302, a controller 303, and a position information acquisition unit 304. Each component is communicatively connected by a communication bus 306. Hereinafter, the description about drop-off vehicle 300 also applies to next riding vehicles 310 to 330.

Communication unit 301 is configured to allow communications with communication unit 110 of fee setting device 100 and communication terminal 200. Communications between communication unit 301 and communication unit 110 and communication terminal 200 are performed via communication network 600.

Storage unit 302 is, for example, a storage device including a nonvolatile memory, a hard disk drive, a solid state drive, or the like. Storage unit 302 stores, for example, information of an SOC of a power storage device mounted in drop-off vehicle 300, information about the position of drop-off vehicle 300, and the like.

Controller 303 includes, for example, a CPU, a memory (ROM and RAM), input/output ports for inputting/outputting various signals, and the like, none of which is shown. Controller 303 is configured to execute predetermined computation processing based on information stored in the memory and storage unit 302.

Further, controller 303 monitors a state of the power storage device mounted in drop-off vehicle 300. For example, controller 303 detects the voltage, current, and temperature of the power storage device, uses these values to estimate an OCV (Open Circuit Voltage), and calculates the SOC of the power storage device. Further, controller 303 may calculate the SOC of the power storage device from an accumulation of amounts of power charged/discharged. The calculation of the SOC may be done using any well-known technique, and accordingly, will not be described specifically.

In addition, for example when drop-off vehicle 300 shifts from a READY-OFF state to a READY-ON state, controller 303 transmits, to fee setting device 100 via communication unit 301, vehicle information for specifying drop-off vehicle 300, together with start-of-utilization information notifying that utilization of drop-off vehicle 300 starts. When drop-off vehicle 300 shifts from the READY-ON state to the READY-OFF state, controller 303 transmits, to fee setting device 100, end-of-utilization information notifying that utilization of drop-off vehicle 300 ends. It should be noted that the READY-ON state refers to a state in which the vehicle is capable of traveling, and the READY-OFF state refers to a state in which the vehicle is incapable of traveling.

Position information acquisition unit 304 is configured to acquire a current position of drop-off vehicle 300. For example, position information acquisition unit 304 uses a GPS (Global Positioning System) to acquire the current position of drop-off vehicle 300. Position information acquisition unit 304 transmits to controller 303 position information indicating the acquired current position of drop-off vehicle 300.

Controller 303 causes storage unit 302 to store information of the calculated SOC and the position information received from position information acquisition unit 304. While drop-off vehicle 300 is in the READY-ON state and the power storage device is being charged, controller 303 periodically transmits to fee setting device 100 the information of the calculated SOC and the position information acquired by position information acquisition unit 304. Further, in response to a request from fee setting device 100, controller 303 transmits, to fee setting device 100 via communication unit 301, the information of the SOC and the position information of drop-off vehicle 300. Further, when drop-off vehicle 300 shifts from the READY-ON state to the READY-OFF state, controller 303 transmits, to fee setting device 100 via communication unit 301, the information of the SOC and the position information of drop-off vehicle 300.

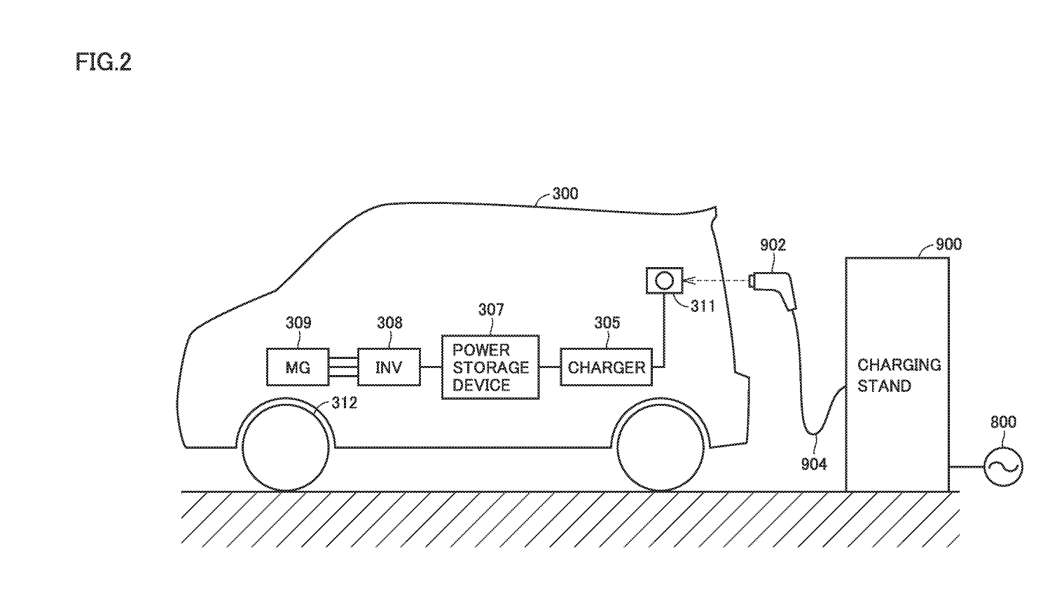

FIG. 2 is a diagram showing an example of a detailed configuration for charging a vehicle in accordance with the present embodiment. FIG. 2 does not show communication unit 301, controller 303, and the like shown in FIG. 1.

As shown in FIG. 2, drop-off vehicle 300 further includes a charger 305, a power storage device 307, an inverter 308, a motor generator 309, and an inlet 311.

When a charging connector 902 of a charging stand 900 is connected to inlet 311, charger 305 charges power storage device 307 with power supplied from an external power source 800.

Power storage device 307 is configured using a secondary battery such as a nickel metal hydride battery or a lithium ion battery, for example. Power storage device 307 may be any power storage device capable of storing power, and for example, a large-capacity capacitor may be used instead of a secondary battery.

Inverter 308 is a power conversion device which converts power between AC power and DC power. For example, inverter 308 converts DC power of power storage device 307 into AC power and supplies it to motor generator 309. Further, for example, inverter 308 converts AC power (regenerative power) from motor generator 309 into DC power, and supplies it to power storage device 307 to charge power storage device 307.

Motor generator 309 receives power supplied from inverter 308 and provides rotational force to drive wheels 312. Drive wheels 312 are rotated by the rotational force provided by motor generator 309 to drive drop-off vehicle 300.

Inlet 311 is provided to an exterior portion of drop-off vehicle 300 together with a cover (not shown) such as a lid. Inlet 311 has a shape allowing charging connector 902 to be connected thereto. Inlet 311 and charging connector 902 both have contacts, respectively, built therein, and when charging connector 902 is connected to inlet 311, the contacts come into contact with each other, and inlet 311 and charging connector 902 are thus electrically connected.

Charging stand 900 is installed outside drop-off vehicle 300 and connected to charging connector 902 via a charging cable 904. Charging stand 900 is electrically connected to power source 800. When charging connector 902 is connected to inlet 311, the power of power source 800 is supplied to drop-off vehicle 300 via charging stand 900, charging cable 904, and charging connector 902.

It should be noted that next riding vehicles 310 to 330 have the same configuration as that of drop-off vehicle 300. Accordingly, the detailed description thereof will not be repeated.

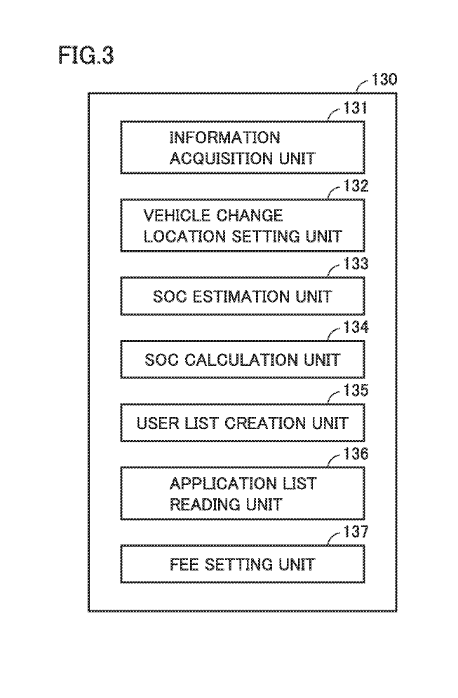

FIG. 3 is a functional block diagram showing a configuration of controller 130 of fee setting device 100 in accordance with the present embodiment. Controller 130 includes an information acquisition unit 131, a vehicle change location setting unit 132, an SOC estimation unit 133, an SOC calculation unit 134, a user list creation unit 135, an application list reading unit 136, and a fee setting unit 137.

Information acquisition unit 131 acquires, from a vehicle via communication unit 110, start-of-utilization information, end-of-utilization information, vehicle information, SOC information, position information, and the like. Further, information acquisition unit 131 requests to a vehicle, via communication unit 110, for SOC information and position information.

Vehicle change location setting unit 132 sets a vehicle change location where the user will change vehicles from drop-off vehicle 300 to next riding vehicles 310 to 330, based on an SOC of drop-off vehicle 300 estimated when the user arrives at a destination using drop-off vehicle 300 without changing vehicles from a place of departure to the destination (hereinafter also referred to as a “first estimated SOC”) calculated by SOC estimation unit 133. Specifically, when the first estimated SOC is lower than a predetermined value, vehicle change location setting unit 132 sets a first vehicle change location where the user will change the vehicle to next riding vehicle 310. It should be noted that the first vehicle change location is set such that an SOC of drop-off vehicle 300 estimated when the user arrives at the first vehicle change location does not become lower than the predetermined value. Then, when an SOC of next riding vehicle 310 estimated when the user arrives at the destination using next riding vehicle 310 from the first vehicle change location to the destination (hereinafter also referred to as a “second estimated SOC”) calculated by SOC estimation unit 133 is lower than the predetermined value, vehicle change location setting unit 132 sets a second vehicle change location where the user will change vehicles from next riding vehicle 310 to next riding vehicle 320. It should be noted that the second vehicle change location is set such that an SOC of next riding vehicle 310 estimated when the user arrives at the second vehicle change location does not become lower than the predetermined value. Hereinafter, vehicle change location setting unit 132 similarly sets a vehicle change location until the second estimated SOC estimated when the user arrives at the destination using a next riding vehicle from an N-th vehicle change location for performing an N-th vehicle change to the destination becomes more than or equal to the predetermined value. It should be noted that the first estimated SOC corresponds to the “first estimated power storage amount” in accordance with the present disclosure. Further, the second estimated SOC corresponds to the “second estimated power storage amount” in accordance with the present disclosure.

SOC estimation unit 133 calculates an SOC of drop-off vehicle 300 at the time of departure estimated when the user reserves the vehicle, and an SOC of drop-off vehicle 300 estimated when the user arrives at the destination. Specifically, when the user reserves drop-off vehicle 300 using communication terminal 200, SOC estimation unit 133 calculates an SOC estimated at a time point when the user starts using drop-off vehicle 300. Further, SOC estimation unit 133 calculates the first estimated SOC. Furthermore, when a vehicle change location is set by vehicle change location setting unit 132, SOC estimation unit 133 calculates the second estimated SOC.

SOC calculation unit 134 detects voltages, currents, and temperatures of power storage devices 307 of dro-off vehicle 300 and next riding vehicles 310 to 330, and uses these values to calculate SOCs of power storage devices 307.

User list creation unit 135 creates user list 700 described later, using the vehicle change location set by vehicle change location setting unit 132, the SOCs of drop-off vehicle 300 and next riding vehicles 310 to 330 calculated by SOC calculation unit 134, and the like.

Application list reading unit 136 reads an application list 750 described later which is stored in storage unit 120.

Fee setting unit 137 sets a sharing fee to be billed to the user who utilizes the vehicle. Fee setting unit 137 determines the sharing fee based on an SOC of the power storage device of the vehicle (hereinafter also referred to simply as an “SOC of the vehicle”) when the user returns the vehicle, whether or not a discount is applied, and the like. Details of setting the sharing fee will be described later.

### As to EV Car Sharing

Generally, in an electric vehicle configured as described above, the travelable distance of the electric vehicle with a fully-charged power storage device is shorter than that of a vehicle driven by an internal combustion engine. In addition, the electric vehicle requires a longer time for replenishment of driving energy than that for the vehicle driven by an internal combustion engine. Specifically, the time required for replenishment of driving energy is the time required to supply fuel in the case of the vehicle driven by an internal combustion engine, and is the time required to charge the power storage device in the case of the electric vehicle.

Accordingly, in EV car sharing, a user may willingly select an electric vehicle in which an SOC of the electric vehicle reaches a certain charge level or more. On the other hand, a user may not select an electric vehicle in which the SOC is less than the certain level, and the efficiency of utilizing EV car sharing may be reduced.

Thus, there is a demand for an EV car sharing system which encourages utilization of an electric vehicle in which the SOC does not reach a certain level or more.

In the present embodiment, a user connects to fee setting device 100 and reserves drop-off vehicle 300, using communication terminal 200. In response to input of a station from which the user will depart (hereinafter also referred to as a “departure station”) and a station which is a destination (hereinafter also referred to as an “arrival station”) through communication terminal 200, fee setting device 100 calculates an SOC of drop-off vehicle 300 estimated at the time of departure. Then, fee setting device 100 calculates an SOC of drop-off vehicle 300 estimated at the time of arrival at the arrival station (the first estimated SOC), using a distance from the departure station to the arrival station and the like. Then, when the first estimated SOC is lower than a predetermined value, fee setting device 100 sets a station where the user will change vehicles (hereinafter also referred to as a “vehicle change station”), and presents it to communication terminal 200 (the user). When the user changes vehicles at the vehicle change station, fee setting device 100 applies a first vehicle change discount to a utilization fee for a next riding vehicle. That is, when the user changes vehicles from drop-off vehicle 300 to next riding vehicles 310 to 330, fee setting device 100 applies the first vehicle change discount to the utilization fee for next riding vehicles 310 to 330. It should be noted that the vehicle change station corresponds to the “vehicle change location” in the present disclosure.

Thereby, the user is encouraged to use drop-off vehicle 300 with a power storage device having a low power storage amount to travel to the vehicle change station, and then change the vehicle to next riding vehicle 310 at the vehicle change station to travel to the arrival station. Accordingly, utilization of drop-off vehicle 300 with the power storage device having a low power storage amount is promoted. Therefore, the efficiency of utilizing the electric vehicle is enhanced.

In addition, when the user changes vehicles at the vehicle change station, fee setting device 100 calculates an SOC of drop-off vehicle 300 at the vehicle change station. When the calculated SOC is more than or equal to a reference value, fee setting device 100 applies a second vehicle change discount to a utilization fee for drop-off vehicle 300.

Thereby, the user is encouraged to return drop-off vehicle 300 with a power storage amount higher than the reference value remaining therein. This reduces the time required to charge drop-off vehicle 300 after returning of drop-off vehicle 300, and thus enhances the efficiency of utilizing drop-off vehicle 300.

### As to User List

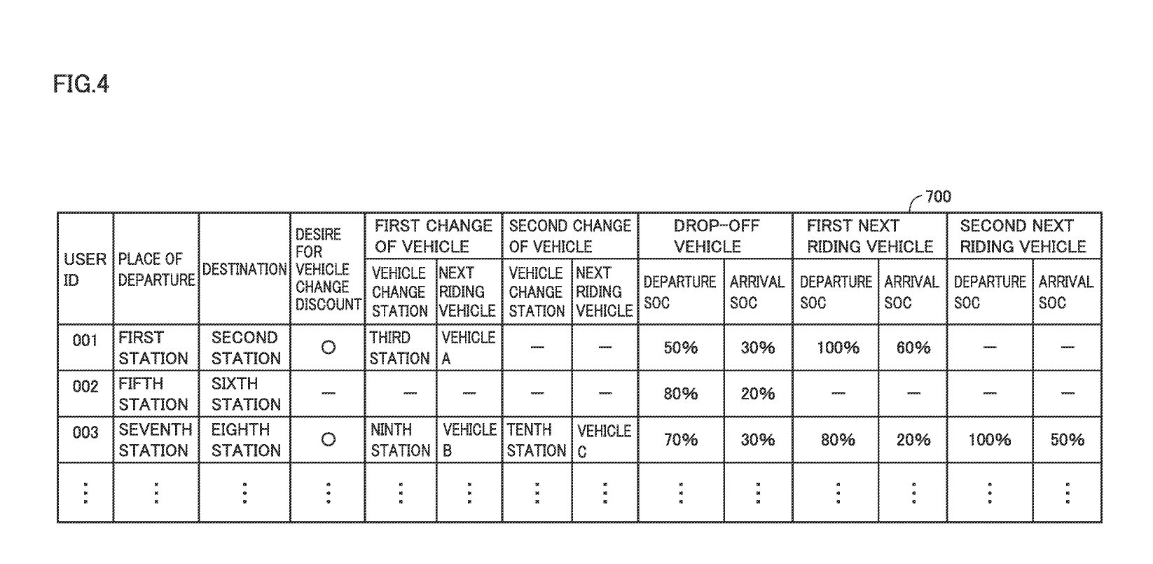

FIG. 4 is a diagram showing an example of a configuration of user list 700 stored in fee setting device 100 in accordance with the present embodiment. As shown in FIG. 4, in the present embodiment, a place of departure, a destination, a desire for a vehicle change discount, first change of vehicle, second change of vehicle, a drop-off vehicle, a first next riding vehicle, and a second next riding vehicle are registered in user list 700 for each user ID.

Fee setting device 100 updates user list 700 stored in storage unit 120 each time fee setting device 100 receives information of any of the items described above. Further, user list 700 is also updated when controller 130 of fee setting device 100 requests and acquires information of an SOC of a vehicle.

A user ID is issued to a user when membership registration for EV car sharing is completed, and is used to specify the user.

The items of the place of departure and the destination are input to communication terminal 200 by the user. Controller 130 of fee setting device 100 acquires the input information from communication terminal 200, and registers the acquired information in user list 700.

The item of the desire for the vehicle change discount is input to communication terminal 200 by the user. Controller 130 acquires the input information from communication terminal 200, and registers the acquired information in user list 700.

The items of first change of vehicle and second change of vehicle are items used for a user who has a desire for the vehicle change discount. Information about a first vehicle change is registered in the item of first change of vehicle, and information about a second vehicle change is registered in the item of second change of vehicle. Specifically, the items of first change of vehicle and second change of vehicle each include items of a vehicle change station and a next riding vehicle. For the user who has a desire for the vehicle change discount, a vehicle change station selected by the user from vehicle change stations set by controller 130 is registered in user list 700. Further, next riding vehicle 310 selected by controller 130 from vehicles at the vehicle change station selected by the user is registered in user list 700. It should be noted that, as next riding vehicle 310 selected by controller 130, a vehicle comparable to drop-off vehicle 300 is selected. It should be noted that, although the next riding vehicle is selected by controller 130 in the present embodiment, it may be registered by the user's selection.

The item of the drop-off vehicle includes items of a departure SOC and an arrival SOC, and actual use results are registered. In the item of the departure SOC, an SOC of drop-off vehicle 300 at a departure station is registered. In the item of the arrival SOC, an SOC of drop-off vehicle 300 at an arrival station is registered.

The items of the first next riding vehicle and the second next riding vehicle each include items of a departure SOC and an arrival SOC, and actual use results are registered. In the item of the departure SOC, an SOC of next riding vehicle 310 at a departure station is registered. In the item of the arrival SOC, an SOC of next riding vehicle 310 at an arrival station is registered. Specifically, for example, for a user having a user ID 001, a departure SOC and an arrival SOC of a vehicle A are registered in the item of the first next riding vehicle. For example, for a user having a user ID 003, a departure SOC and an arrival SOC of a vehicle B are registered in the item of the first next riding vehicle.

The user having user ID 001 is an exemplary user who desires application of the vehicle change discount and selects first change of vehicle. For example, the user having user ID 001 selects a first station as a place of departure, and selects a second station as a destination. Further, the user desires application of the vehicle change discount, and it is registered that the user will change the vehicle to vehicle A at a third station. In addition, as the use results acquired through actual utilization of the vehicles, it is registered that the departure SOC in the item of the drop-off vehicle is 50%, the arrival SOC in the item of the drop-off vehicle is 30%, the departure SOC in the item of the first next riding vehicle is 100%, and the arrival SOC in the item of the first next riding vehicle is 60%.

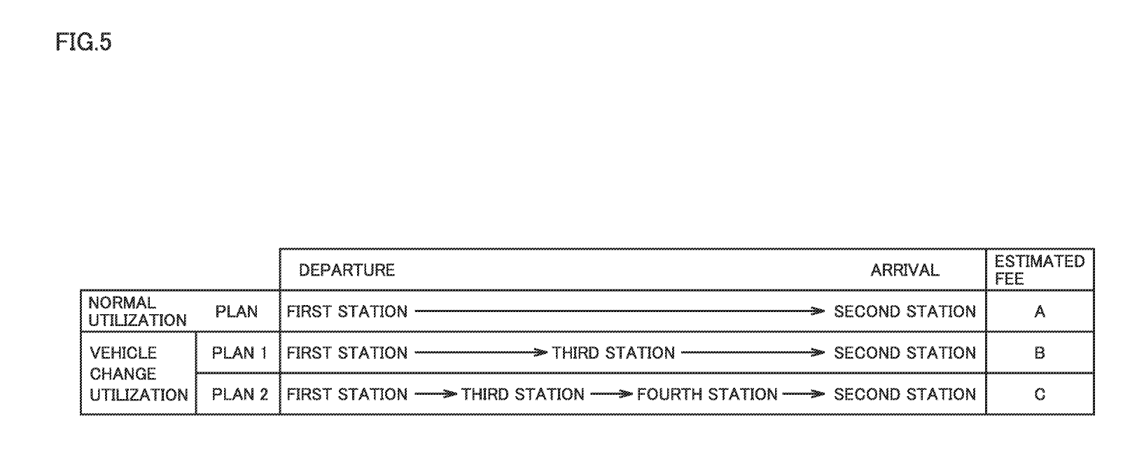

Specifically, the user having user ID 001 is allowed to make a selection as illustrated in FIG. 5. FIG. 5 is a diagram showing an example of a selection screen displayed in communication terminal 200 in accordance with the present embodiment. When the place of departure (the first station) and the destination (the second station) are input by the user, controller 130 calculates the first estimated SOC. When the first estimated SOC is lower than the predetermined value, controller 130 sets the third station. Then, controller 130 calculates the second estimated SOC. When the second estimated SOC is lower than the predetermined value, controller 130 sets a fourth station between the third station and the destination. Further, controller 130 calculates the second estimated SOC based on the fourth station. When the second estimated SOC is more than or equal to the predetermined value, controller 130 presents the set vehicle change stations as plans shown in FIG. 5, to communication terminal 200 (the user). In addition, a utilization fee estimated when each plan is selected is calculated by controller 130 and displayed.

A normal utilization plan is a plan in which the user will not change vehicles. An estimated fee, which is an estimated utilization fee, is calculated as an estimated fee A and displayed. A vehicle change utilization plan 1 is a plan in which the user will change vehicles once at the third station. An estimated fee is calculated as an estimated fee B and displayed. A vehicle change utilization plan 2 is a plan in which the user will change vehicles twice at the third station and the fourth station. An estimated fee is calculated as an estimated fee C and displayed. Basically, these estimated fees have a relation that estimated fee C<estimated fee B<estimated fee A.

The user can select any plan from the displayed plans.

Turning back to FIG. 4, a user having a user ID 002 is an exemplary user who does not desire application of the vehicle change discount. Since the user having user ID 002 does not change vehicles, only the item of the drop-off vehicle is registered as a use result. The user having user ID 002 selects a fifth station as a place of departure, and selects a sixth station as a destination. In addition, as the use results acquired through actual utilization of the vehicle, it is registered that the departure SOC in the item of the drop-off vehicle is 80%, and the arrival SOC in the item of the drop-off vehicle is 20%.

The user having user ID 003 is an exemplary user who desires application of the vehicle change discount and selects changing vehicles twice. The user having user ID 003 selects a seventh station as a place of departure, and selects an eighth station as a destination. In addition, as the use results acquired through actual utilization of the vehicles, it is registered that the departure SOC in the item of the drop-off vehicle is 70%, the arrival SOC in the item of the drop-off vehicle is 30%, the departure SOC in the item of the first next riding vehicle is 80%, the arrival SOC in the item of the first next riding vehicle is 20%, the departure SOC in the item of the second next riding vehicle is 100%, and the arrival SOC in the item of the second next riding vehicle is 50%.

### As to Application List

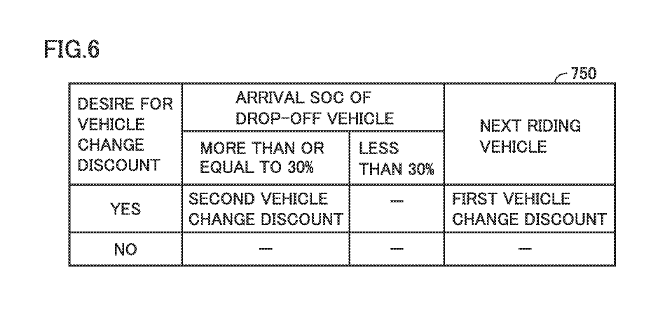

FIG. 6 is a diagram showing an example of a configuration of application list 750 stored in fee setting device 100 in accordance with the present embodiment. In the present embodiment, a desire for a vehicle change discount, an arrival SOC of a drop-off vehicle, and a next riding vehicle are registered in application list 750. Fee setting unit 137 of fee setting device 100 checks the information registered in user list 700 against application list 750 to determine whether or not to apply the discount.

First, when the vehicle change discount is desired in user list 700, controller 130 applies the first vehicle change discount to the utilization fee for next riding vehicle 310. Then, when the arrival SOC in the item of the drop-off vehicle is more than or equal to the reference value, controller 130 applies the second vehicle change discount to the utilization fee for drop-off vehicle 300. When the arrival SOC in the item of the drop-off vehicle is less than the reference value, controller 130 does not apply the second vehicle change discount to the utilization fee for drop-off vehicle 300. The reference value is 30%, for example, and FIG. 6 shows an example where the reference value is 30%.

When the vehicle change discount is not desired, controller 130 applies neither the first vehicle change discount nor the second vehicle change discount.

Specifically, when “0” is input in a column for the desire for the vehicle change discount in user list 700, controller 130 refers to a column for the desire for the vehicle change discount input as “YES” in application list 750. Then, controller 130 applies the first vehicle change discount to the utilization fee for next riding vehicle 310. For the user having user ID 001, controller 130 applies the first vehicle change discount to the utilization fee for vehicle A. For the user having user ID 003, controller 130 applies the first vehicle change discount to the utilization fees for vehicles B and C.

Then, controller 130 determines whether the arrival SOC in the item of the drop-off vehicle is more than or equal to 30% in user list 700. For both of the user having user ID 001 and the user having user ID 003, the arrival SOC of the SOCs of the drop-off vehicle is 30%. Therefore, controller 130 applies the second vehicle change discount to the utilization fees for drop-off vehicles 300 of the both users.

For the user having user ID 002, since the user does not desire application of the vehicle change discount, controller 130 applies neither the first vehicle change discount nor the second vehicle change discount.

### As to Fee Setting Method

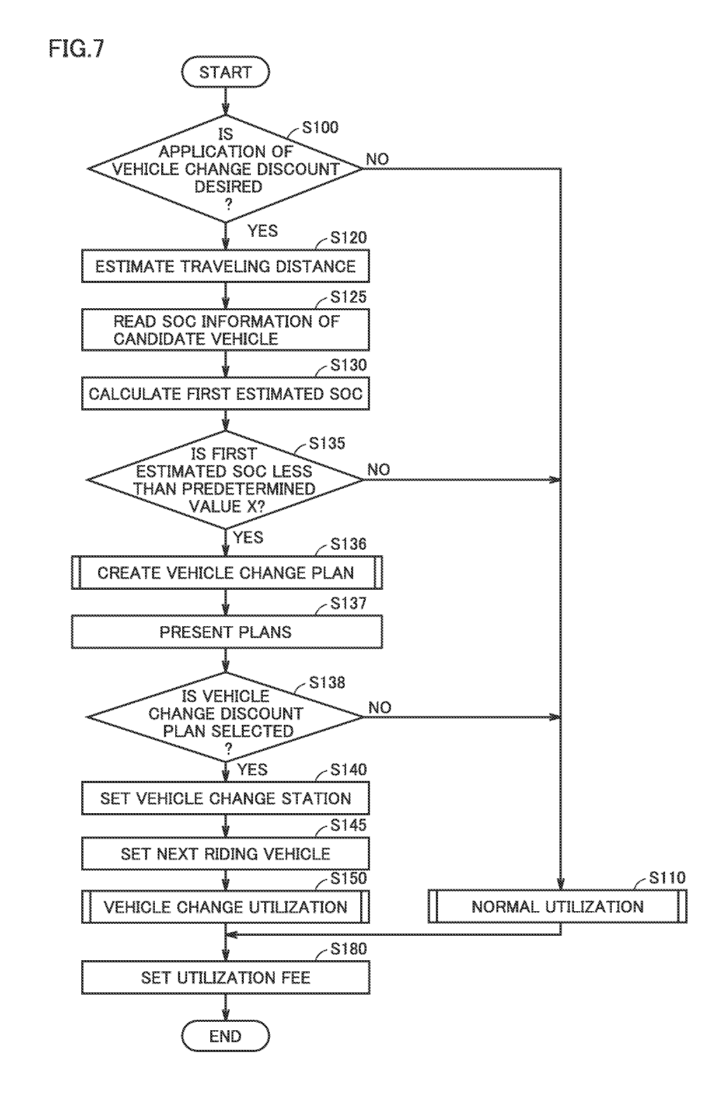

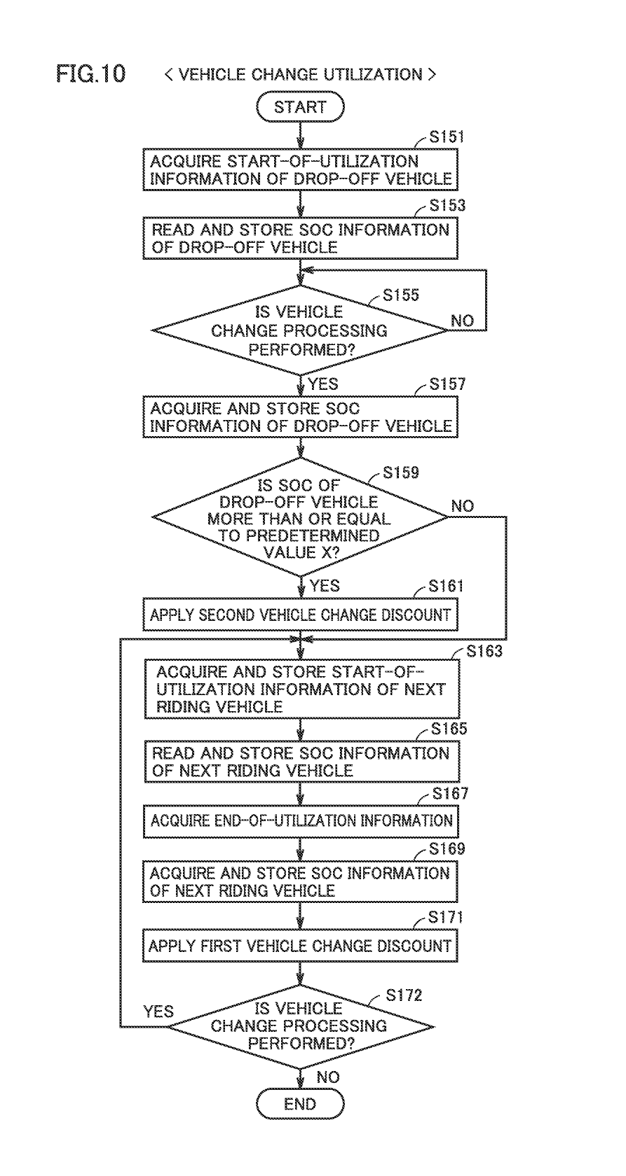

FIG. 7 is a flowchart showing processing performed by fee setting device 100 in accordance with the present embodiment. This processing is performed each time a user reserves a vehicle in fee setting system 1. It should be noted that, although each step in the flowchart shown in FIG. 7 is implemented by software processing performed by fee setting device 100, a part thereof may be implemented by hardware (electric circuitry) fabricated within fee setting device 100. The same applies to each step in the flowchart shown in FIG. 10.

When controller 130 receives information of a place of departure and a destination input by the user through communication terminal 200, controller 130 requests the user to select whether the user desires application of a vehicle change discount (step 100; hereinafter each step will be abbreviated as “S”).

When controller 130 receives information that the user has selected not to desire application of the vehicle change discount (NO in S100), controller 130 selects normal utilization (S110).

When controller 130 receives information that the user has selected to desire application of the vehicle change discount (YES in S100), controller 130 calculates a traveling distance from the place of departure to the destination, based on the received information of the place of departure and the destination (S120). Controller 130 reads SOC information of drop-off vehicle 300 reserved by the user, and calculates an estimated SOC of drop-off vehicle 300 at the time of departure (S125). The estimated SOC of drop-off vehicle 300 at the time of departure is calculated using SOC information at present, a charging status, a reservation status before the user uses drop-off vehicle 300, and the like.

Controller 130 calculates an estimated SOC of drop-off vehicle 300 at the time of arrival (a first estimated SOC), based on the traveling distance calculated in S120 and the estimated SOC of drop-off vehicle 300 at the time of departure calculated in S125 (S130).

When the estimated SOC of drop-off vehicle 300 at the time of arrival is more than or equal to a predetermined value X (NO in S135), controller 130 selects normal utilization (S110).

When the first estimated SOC is less than predetermined value X (YES in S135), controller 130 sets a vehicle change station and creates a vehicle change plan (S136). Details of the vehicle change plan will be described later. Controller 130 presents plans including the vehicle change plan created in S136 (S137). It should be noted that, although predetermined value X can be set arbitrarily, predetermined value X is set within a range in which it allows a next user to utilize the vehicle immediately or after a short time of charging, and it does not cause deterioration of the power storage device.

When the user selects a plan to which the vehicle change discount will not be applied, from a plurality of presented plans (NO in S138), controller 130 selects normal utilization (S110). When the user selects a plan to which the vehicle change discount will be applied, from the plurality of presented plans (YES in S138), controller 130 sets the vehicle change station in the selected plan, and registers it in user list 700 (S140).

Controller 130 sets next riding vehicle 310 comparable to drop-off vehicle 300, and registers it in user list 700 (S145). Controller 130 selects vehicle change utilization (S150). Then, controller 130 performs processing in normal utilization (S110) or vehicle change utilization (S150) described later, and sets a utilization fee (S180).

### As to Creation of Vehicle Change Plan

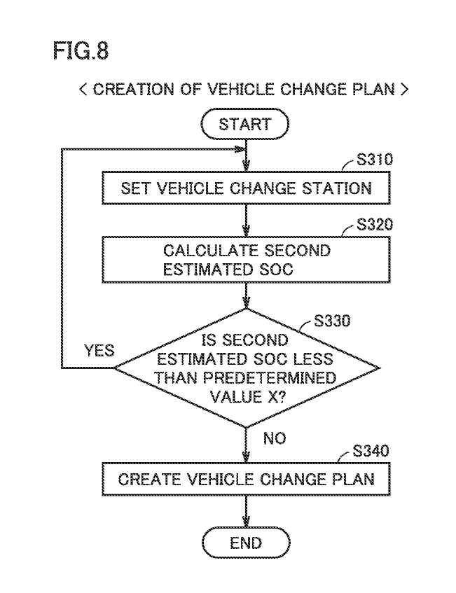

FIG. 8 is a flowchart showing processing in creating the vehicle change plan performed by fee setting device 100 in accordance with the present embodiment.

Controller 130 sets a first vehicle change station such that an SOC of drop-off vehicle 300 estimated when the user arrives at the first vehicle change station from a departure station does not become lower than the predetermined value (S310).

Controller 130 calculates a second estimated SOC based on a distance between the first vehicle change station and a destination, and an SOC of next riding vehicle 310 (S320).

When the second estimated SOC is more than or equal to predetermined value X (NO in S330), controller 130 creates the vehicle change plan (S340). It should be noted that, in this case, a normal plan and a plan in which the user will change vehicles once are presented in S137 of FIG. 7.

On the other hand, when the second estimated SOC is less than predetermined value X (YES in S330), controller 130 returns the processing to S310, and further sets a second vehicle change station between the first vehicle change station and the destination. Hereinafter, controller 130 similarly performs the processing in S310 to S330, and performs the processing of FIG. 8 until the second estimated SOC becomes more than or equal to the predetermined value.

### As to Normal Utilization

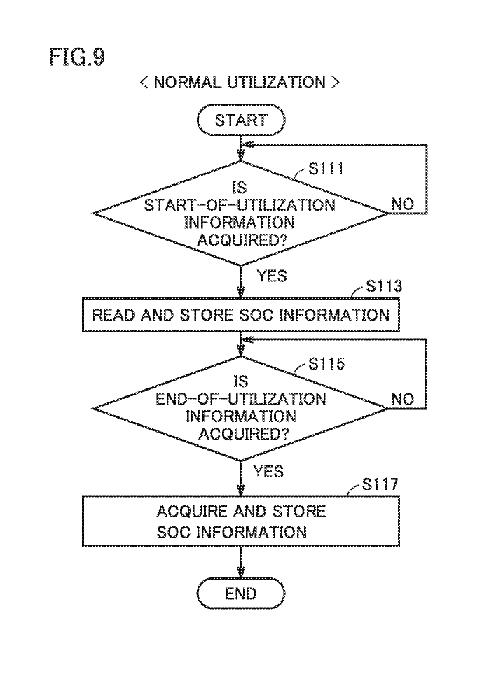

FIG. 9 is a flowchart showing processing in normal utilization performed by fee setting device 100 in accordance with the present embodiment.

When controller 130 acquires start-of-utilization information notifying that utilization of drop-off vehicle 300 starts (YES in S111), controller 130 reads SOC information from drop-off vehicle 300 and registers it in user list 700 (S113).

Controller 130 waits until it acquires end-of-utilization information notifying that utilization of drop-off vehicle 300 ends (NO in S115). When controller 130 acquires the end-of-utilization information (YES in S115), controller 130 reads SOC information from drop-off vehicle 300 and registers it in user list 700 (S117).

### As to Vehicle Change Utilization

FIG. 10 is a flowchart showing processing in vehicle change utilization performed by fee setting device 100 in accordance with the present embodiment.

When controller 130 acquires start-of-utilization information notifying that utilization of drop-off vehicle 300 starts (S151), controller 130 reads SOC information from drop-off vehicle 300 and registers it in user list 700 (S153).

Controller 130 waits until vehicle change processing is performed (NO in S155). When vehicle change processing is performed (YES in S155), controller 130 reads SOC information from drop-off vehicle 300 and registers it in user list 700 (S157). It should be noted that, in the present embodiment, it is determined that vehicle change processing is performed when controller 130 acquires end-of-utilization information notifying that utilization of drop-off vehicle 300 ends. It may be determined that vehicle change processing is performed when controller 130 acquires start-of-utilization information notifying that utilization of next riding vehicle 310 starts.

Controller 130 determines whether an SOC of drop-off vehicle 300 is more than or equal to predetermined value X (S159). When controller 130 determines that the SOC of drop-off vehicle 300 is less than predetermined value X (NO in S159), controller 130 proceeds the processing to S163 without applying the second vehicle change discount to the utilization fee for drop-off vehicle 300.

When controller 130 determines that the SOC of drop-off vehicle 300 is more than or equal to predetermined value X (YES in S159), controller 130 applies the second vehicle change discount to the utilization fee for drop-off vehicle 300 (S161).

When controller 130 acquires start-of-utilization information notifying that utilization of next riding vehicle 310 starts (S163), controller 130 reads SOC information from next riding vehicle 310 and registers it in user list 700 (S165).

When controller 130 acquires end-of-utilization information notifying that utilization of next riding vehicle 310 ends (S167), controller 130 reads SOC information from next riding vehicle 310 and registers it in user list 700 (S169). Controller 130 applies the first vehicle change discount to the utilization fee for next riding vehicle 310 (S171).

Controller 130 refers to user list 700 and determines whether or not vehicle change processing is performed (S172). When controller 130 determines that vehicle change processing is not performed (NO in S172), controller 130 terminates the processing. On the other hand, when controller 130 determines that vehicle change processing is performed (YES in S172), controller 130 returns the processing to S163, and performs the processing in S163 to S172 for next riding vehicle 320. Controller 130 similarly performs the processing in the case of changing vehicles N times.

It should be noted that, although the same predetermined value X is used in S159 and S135 of FIG. 7 in the present embodiment, different values may be used.

### As to Self-Pay Charging

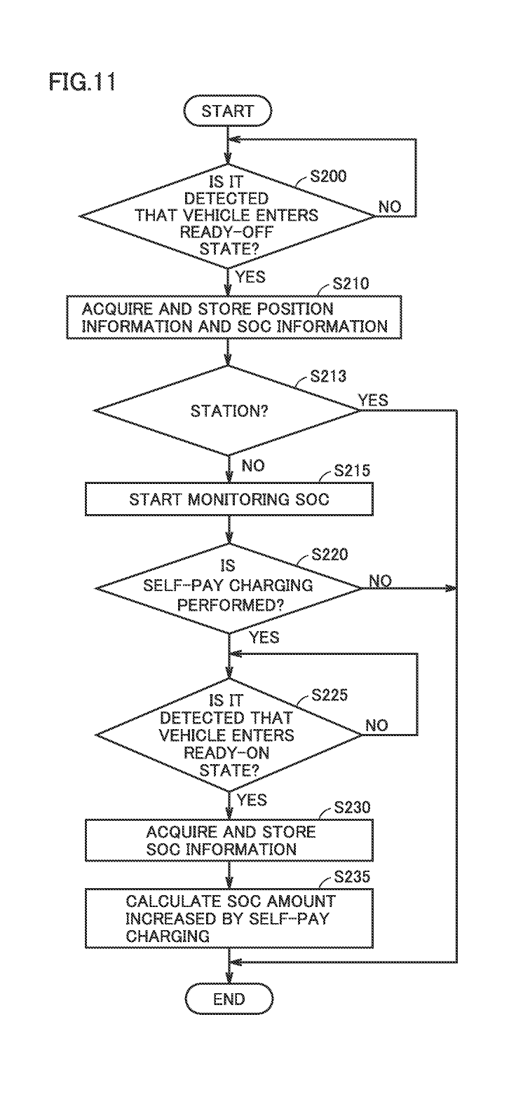

FIG. 11 is a flowchart showing processing at the time of self-pay charging performed by fee setting device 100 in accordance with the present embodiment.

For example, there may be a case where a user charges a vehicle at the user's own expense at a public charging station or the like. In the present embodiment, as explained in examples described later, a utilization fee is set according to utilized power used by the user through utilization of the vehicle. Thus, in a case where the utilized power used by the user is calculated from an SOC of the vehicle at the start of utilization and an SOC of the vehicle at the end of utilization, if the user performs self-pay charging, it is not possible to accurately calculate the utilized power. Therefore, such a problem is avoided by a method described below.

When controller 130 detects that the vehicle enters the READY-OFF state (YES in S200), controller 130 acquires position information of the vehicle and SOC information of the vehicle, and causes storage unit 120 to store them (S210).

Controller 130 determines whether or not the acquired position information indicates a specified position such as a station (S213). When controller 130 determines that the acquired position information indicates a specified position (YES in S213), controller 130 terminates the processing. When controller 130 determines that the acquired position information does not indicate a specified position (NO in S213), controller 130 monitors the SOC information of the vehicle (S215), and determines whether self-pay charging is performed based on the SOC of the vehicle (S220). Whether or not self-pay charging is performed is determined based on whether or not the SOC acquired from the vehicle is increasing. When the SOC is increasing although the vehicle is in the READY-OFF state, controller 130 determines that self-pay charging is performed. When the SOC is not increasing, controller 130 determines that self-pay charging is not performed.

When controller 130 determines that self-pay charging is not performed (NO in S220), controller 130 terminates the processing. When controller 130 determines that self-pay charging is performed (YES in S220), controller 130 waits until it detects that the vehicle enters the READY-ON state (NO in S225).

When controller 130 detects that the vehicle enters the READY-ON state (YES in S225), controller 130 acquires SOC information of the vehicle and causes storage unit 120 to store it (S230).

Controller 130 calculates an SOC amount increased by self-pay charging, based on the SOC of the vehicle acquired in S210 and the SOC of the vehicle acquired in S230 (S235). The utilized power used by the user can be calculated by subtracting the SOC amount increased by self-pay charging, based on the utilized power calculated from the SOC of the vehicle at the start of utilization and the SOC of the vehicle at the end of utilization.

### As to Examples

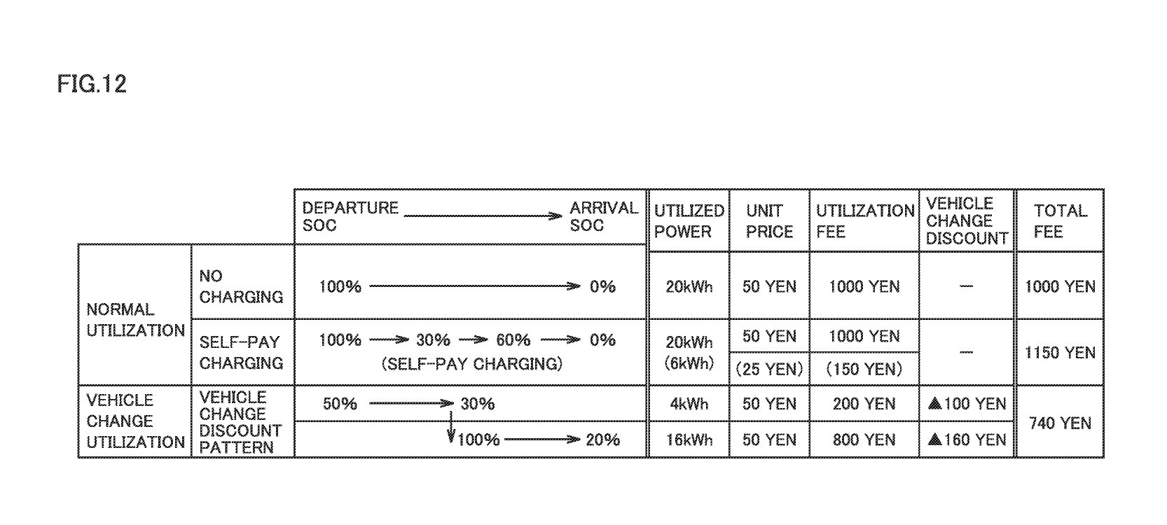

The present embodiment will now be described using examples. FIG. 12 is a diagram for explaining examples to which the configuration of the present embodiment is applied. In the following description, for easier explanation, the description will be given based on an assumption that a power storage capacity, a degraded state, and the like of a power storage device mounted in each vehicle are comparable in all vehicles. Further, it is assumed that utilized power required to travel from a place of departure to a destination is uniformly set to 20 kWh, and a power unit price is 50 yen. It is also assumed that a discount rate for the first vehicle change discount is 20% of the utilization fee, and a discount rate for the second vehicle change discount is 50% of the utilization fee.

In the case of normal utilization (without self-pay charging), since the utilized power is 20 kWh and the power unit price is 50 yen, the utilization fee is 1000 yen. Since no discount is applied, the total fee is 1000 yen.

In the case of vehicle change utilization, drop-off vehicle 300 is changed at a time point when its SOC decreases from 50% to 30%, and then next riding vehicle 310 is used while its SOC decreases from 100% to 20%. Since drop-off vehicle 300 is returned with an SOC of 30%, the second vehicle change discount is applied. Since the utilized power used by drop-off vehicle 300 is 4 kWh, the utilization fee is 200 yen, and 100 yen is discounted therefrom by the application of the second vehicle change discount. Since the utilized power used by next riding vehicle 310 is 16 kWh, the utilization fee is 800 yen, and 160 yen is discounted therefrom by the application of the first vehicle change discount. Therefore, the total fee is 740 yen, which is lower than that in the case of normal utilization.

It should be noted that, in the case of normal utilization (with self-pay charging), a fee for self-pay charging is added to the total fee in the case of normal utilization (without self-pay charging). When it is assumed that a power unit price for self-pay charging is 25 yen and utilized power of 6 kWh is used, an added utilization fee is 150yen. Therefore, the total fee is 1150 yen, which is the highest utilization fee.

As described above, in the present embodiment, a user connects to fee setting device 100 and reserves drop-off vehicle 300, using communication terminal 200. When a departure station and an arrival station are input through communication terminal 200, fee setting device 100 calculates an SOC of drop-off vehicle 300 estimated at the time of departure. Then, fee setting device 100 calculates an SOC of drop-off vehicle 300 estimated at the time of arrival at the arrival station (the first estimated SOC), using a distance from the departure station to the arrival station and the like. Then, when the SOC of drop-off vehicle 300 estimated at the time of arrival is lower than a predetermined value, fee setting device 100 sets a vehicle change station, and presents it to communication terminal 200 (the user). When the user changes vehicles at the vehicle change station, fee setting device 100 applies the first vehicle change discount. That is, when the user changes vehicles from drop-off vehicle 300 to next riding vehicle 310, fee setting device 100 applies the first vehicle change discount to the utilization fee for next riding vehicle 310.

Thereby, the user is encouraged to use drop-off vehicle 300 with a power storage device having a low power storage amount to travel to the vehicle change station, and then change the vehicle to next riding vehicle 310 at the vehicle change station to travel to the arrival station. Accordingly, utilization of drop-off vehicle 300 with the power storage device having a low power storage amount is promoted. Therefore, the efficiency of utilizing the electric vehicle is enhanced.

In addition, when the user changes vehicles at the vehicle change station, fee setting device 100 calculates an SOC of drop-off vehicle 300 at the vehicle change station. When the calculated SOC is more than or equal to a reference value, fee setting device 100 applies the second vehicle change discount to the utilization fee for drop-off vehicle 300.

Thereby, the user is encouraged to return drop-off vehicle 300 with a power storage amount higher than the reference value remaining therein. This reduces the time required to charge drop-off vehicle 300 after returning of drop-off vehicle 300, and thus enhances the efficiency of utilizing drop-off vehicle 300.

### Variation

In the present embodiment, in the case where the first estimated SOC is less than predetermined value X, the first vehicle change station (first vehicle change location) is set. In this case, when the SOC of the next riding vehicle estimated at the time of arrival at the arrival station (the second estimated SOC) is less than the predetermined value, a vehicle change station is further set. However, vehicle change stations may be set as described below.

In the case where the first vehicle change station is set, when an SOC of first next riding vehicle 310 required to set an SOC of a next riding vehicle at the time of arrival at the arrival station (destination) to more than or equal to predetermined value X (hereinafter also referred to as a “third estimated SOC”) is required to be more than or equal to a threshold value Y, a second vehicle change station is set. When the third estimated SOC is more than or equal to threshold value Y, the second vehicle change station is set in a case where the calculated third estimated SOC is 100% or more, or in a case where the calculated third estimated SOC is close to a fully charged state. In such a case, it is not possible to set a next riding vehicle or to enhance the efficiency of utilizing a vehicle which is not fully charged. Although threshold value Y can be set arbitrarily, threshold value Y is desirably set in a range in which it can lead to an enhanced efficiency of utilizing a vehicle which is not fully charged, for example to 70%.

As described above, a vehicle change station may be set such that the SOC of the next riding vehicle at the arrival station is more than or equal to the predetermined value and the third estimated SOC is less than the threshold value. It should be noted that the third estimated SOC corresponds to the “third estimated power storage amount” in accordance with the present disclosure.

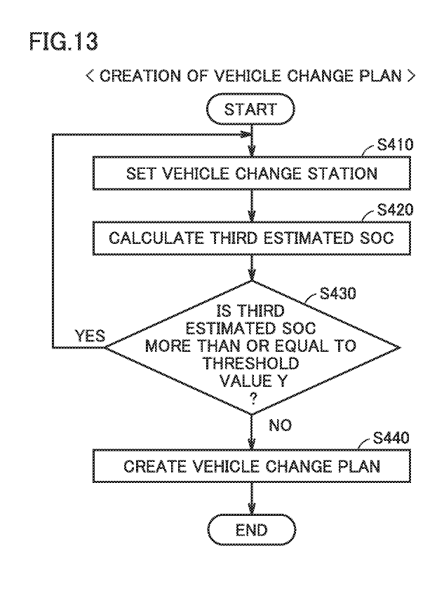

FIG. 13 is a flowchart showing processing in creating a vehicle change plan performed by fee setting device 100 in accordance with a variation.

Controller 130 sets the first vehicle change station such that an SOC of drop-off vehicle 300 estimated when the user arrives at the first vehicle change station from a departure station does not become lower than the predetermined value (S410).

Controller 130 calculates the third estimated SOC based on a distance between the first vehicle change station and a destination, and an SOC of next riding vehicle 310 (S420).

When the third estimated SOC is less than threshold value Y (NO in S430), controller 130 creates the vehicle change plan (S440). It should be noted that, in this case, a normal plan and a plan in which the user will change vehicles once are presented in S137 of FIG. 7.

On the other hand, when the third estimated SOC is more than or equal to threshold value Y (YES in S430), controller 130 returns the processing to S410, and further sets the second vehicle change station between the first vehicle change station and the destination. Hereinafter, controller 130 similarly performs the processing in S410 to S430, and performs the processing of FIG. 13 until the third estimated SOC becomes less than the threshold value.

Although the embodiment of the present disclosure has been described, it should be understood that the embodiment disclosed herein is illustrative and non-restrictive in every respect. The scope of the present disclosure is defined by the scope of the claims, and is intended to include any modifications within the scope and meaning equivalent to the scope of the claims.

What is claimed is:

1. A fee setting device for setting a utilization fee for sharing an electric vehicle, the fee setting device comprising:
a vehicle change location setting unit configured to set a vehicle change location for changing a first electric vehicle to a second electric vehicle, based on designated place of departure and destination; and
a fee setting unit configured to set the utilization fee,
in a first case where the first electric vehicle is changed to the second electric vehicle at a first vehicle change location, the fee setting unit being configured to set the utilization fee to be lower than that in a second case where the first electric vehicle is not changed to the second electric vehicle at the first vehicle change location.

2. The fee setting device according to claim 1, wherein the fee setting unit is configured to estimate the utilization fee in each of the first case and the second case.

3. The fee setting device according to claim 1, wherein
the first and second electric vehicles each include a power storage device mounted thereon,
the fee setting device is configured to estimate a power storage amount in the power storage device of the first electric vehicle at the destination in the second case as a first estimated power storage amount, and
when the first estimated power storage amount is lower than a predetermined value, the vehicle change location setting unit is configured to set the first vehicle change location as the vehicle change location.

4. The fee setting device according to claim 3, wherein
in a case where the vehicle change location setting unit sets the first vehicle change location,
the fee setting device is configured to estimate a power storage amount in the power storage device of the second electric vehicle at the destination in the first case as a second estimated power storage amount, and
when the second estimated power storage amount is lower than the predetermined value, the vehicle change location setting unit is further configured to set a second vehicle change location.

5. The fee setting device according to claim 3, wherein
in a case where the vehicle change location setting unit sets the first vehicle change location,
the fee setting device is configured to estimate a power storage amount in the power storage device of the second electric vehicle at the first vehicle change location as a third estimated power storage amount, the third estimated power storage amount being required to set a power storage amount in the power storage device of the second electric vehicle at the destination in the first case to more than or equal to the predetermined value, and
when the third estimated power storage amount is more than or equal to a threshold value, the vehicle change location setting unit is further configured to set a third vehicle change location.

6. The fee setting device according to claim 1, wherein
when the vehicle change location is set,
in a case where a power storage amount in a power storage device mounted in a drop-off vehicle, which is the electric vehicle before being changed, is higher than a reference value, the fee setting unit is configured to set a utilization fee for the drop-off vehicle to be lower than that in a case where the power storage amount in the power storage device of the drop-off vehicle is lower than the reference value.

7. A method for setting a utilization fee for sharing an electric vehicle, the method comprising:
setting a vehicle change location for changing a first electric vehicle to a second electric vehicle, based on designated place of departure and destination; and
setting the utilization fee in a case where the first electric vehicle is changed to the second electric vehicle at the vehicle change location, to be lower than that in a case where the first electric vehicle is not changed to the second electric vehicle at the vehicle change location.
